(19) United States
(12) Patent Application Publication
(10) Pub. No.: US 2019/0273407 A1
(43) Pub. Date: Sep. 5, 2019

(54) Rotor Assembly with Wedge-Shaped Magnet Pocket

(71) Applicant: Ford Global Technologies, LLC, Dearborn, MI (US)

(72) Inventors: Alfredo R. Munoz, Ann Arbor, MI (US); Feng Liang, Troy, MI (US); Michael Degner, Novi, MI (US); Wei Wu, Northville, MI (US); Chun Tang, Canton, MI (US)

(73) Assignee: Ford Global Technologies, LLC, Dearborn, MI (US)

(21) Appl. No.: 15/909,122

(22) Filed: Mar. 1, 2018

(51) Int. Cl. H02K 1/27

(52) U.S. Cl. CPC H02K 1/2766; H02K 2201/06; H02K 2213/03

(57) ABSTRACT

A rotor for an electric machine assembly including a rotor mount region and a plurality of magnet pockets is provided. The rotor mount region may extend radially about a shaft through-hole. Each of the plurality of magnet pockets may be defined within the rotor mount region. Each magnet pocket may include a central pocket region between an outer pocket region and an inner pocket region. The central pocket region may be sized to receive a magnet having a wedge shape. The central pocket region and the magnet may each have a first side offset at an angle relative to a second side. The outer pocket region may define an outcropped portion extending into the central pocket region. A length of the magnet may be greater than a length between an edge of the magnet adjacent the inner pocket region and an edge of the outcropped portion adjacent the central pocket region.

### TECHNICAL FIELD

The present disclosure relates to assemblies for retaining a magnet within a rotor for an electric machine assembly of an electrified vehicle.

### BACKGROUND

Magnets within rotors of vehicle electric machines may be retained in place via magnet stops. The magnet stops, however, may reduce an operational performance of the magnets and influence the magnets to be more susceptible to demagnetization during electric machine operation. Additionally, a space between the magnet and an edge of a magnet pocket is filled with glue to retain the magnet in position during manufacturing processes which may increase complexity and cost of the manufacturing process.

### SUMMARY

A rotor for an electric machine assembly includes a rotor mount region and a plurality of magnet pockets. The rotor mount region extends radially about a shaft through-hole. Each of the plurality of magnet pockets is defined within the rotor mount region. Each magnet pocket includes a central pocket region between an outer pocket region and an inner pocket region. The central pocket region is sized to receive a magnet having a wedge shape. The central pocket region and the magnet may each have a first side offset at an angle relative to a second side. The outer pocket region may define an outcropped portion extending into the central pocket region. A length of the magnet may be greater than a length between an edge of the magnet adjacent the inner pocket region and an edge of the outcropped portion adjacent the central pocket region. The central pocket region may define a non-uniform shape. The magnet may include two separate magnet units of equal size and shape to fit within the non-uniform shape of the central pocket region. A respective magnet may be spaced from an edge of a respective magnet pocket by a cavity length. The magnet may include a first side defining a first non-vertical length and a second side defining a first vertical length greater than a second vertical length defined by a third side. A distance between an edge of the outer pocket region and an edge of the magnet when located within the central pocket region may be substantially equal to ((2)(the cavity length)(the first non-vertical length))/((the first vertical length)2−(the second vertical length)2). The magnet may include a first vertical side defining a first vertical length, a second vertical side defining a second vertical length, and a third non-vertical side defining a first non-vertical length. A tangent of an angle between a second non-vertical side extending from the second vertical side may be substantially equal to (the first vertical length−the second vertical length)(the first non-vertical length). The central pocket region and the magnet may each have a first side offset at an angle relative to a second side and such that the first side and the second side are not oriented parallel with one another.

A vehicle electric machine assembly includes a stator core and a rotor assembly. The stator core defines a cavity. The rotor assembly is at least partially disposed within the cavity and includes a rotor defining one or more magnet pockets. Each of the magnet pockets includes a central pocket region between an outer pocket region and an inner pocket region. The outer pocket region defines an outcrop extending into the central pocket region. A length of a magnet located within the central pocket region extends past an edge of the outcrop. The rotor may not include a magnet stop located adjacent the magnet pockets. The central pocket region may define an irregular shape and the magnet may be comprised of two separate magnet units of equal size and shape such that both magnet units fit next to one another within the irregular shape of the central pocket region. The magnet and an edge of the central pocket region may define a cavity therebetween having a width such that magnetic flux generated by the magnet is not hindered when the rotor rotates. A respective magnet may be spaced from an edge of a respective magnet pocket by a cavity length. The magnet may include a first side defining a first non-vertical length. The magnet may include a second side defining a first vertical length greater than a second vertical length defined by a third side. A distance between an edge of the outer pocket region and an edge of the magnet when located within the central pocket region may be substantially equal to ((2)(the cavity length)(the first non-vertical length))/((the first vertical length)2−(the second vertical length)2). The magnet may include a first vertical side defining a first vertical length, a second vertical side defining a second vertical length, and a third non-vertical side defining a first non-vertical length. A tangent of an angle between a second non-vertical side extending from the second vertical side may be substantially equal to (the first vertical length−the second vertical length)(the first non-vertical length). The central pocket region may include a first side offset at an angle relative to a second side such that the first side and the second side are not oriented parallel to one another.

A vehicle electric machine assembly includes a stator core and a rotor assembly. The stator core defines a cavity. The rotor assembly is disposed at least partially within the cavity and includes a rotor defining a central shaft through-hole and a magnet pocket sized to receive a wedge-shaped magnet having a first end defining a width greater than a width of a second end. The central shaft through-hole and the magnet pocket are arranged with one another such that the first end of the wedge-shaped magnet is located closer to the central shaft through-hole than the second end of the wedge-shaped magnet. The rotor may not include a magnet stop located adjacent the magnet pockets. A central pocket region of the magnet pocket may define an irregular shape. The magnet may comprise two separate magnet units of equal size and shape such that both magnet units fit next to one another within the irregular shape of the central pocket region. The wedge-shaped magnet may be spaced from an edge of the magnet pocket by a cavity length. The wedge-shaped magnet may include a first side defining a first non-vertical length and a second side defining a first vertical length greater than a second vertical length defined by a third side. A distance between an edge of an outer pocket region of the magnet pocket and an edge of the wedge-shaped magnet when located within a central pocket region of the magnet pocket may be substantially equal to ((2)(the cavity length)(the first non-vertical length))/((the first vertical length)2−(the second vertical length)2). The magnet may include a first vertical side defining a first vertical length, a second vertical side defining a second vertical length, and a third non-vertical side defining a first non-vertical length. A tangent of an angle between a second non-vertical side extending from the second vertical side may be substantially equal to (the first vertical length−the second vertical length)(the first non-vertical length). The first end of the wedge-shaped magnet may be arranged with the central shaft through-hole such that a centripetal force generated by rotation of the rotor influences the magnet to move toward an outer edge of the rotor.

### BRIEF DESCRIPTION OF THE DRAWINGS

FIG. 1 is a perspective, exploded view of an example of a portion of an electric machine assembly.

FIG. 2 is a front view illustrating an example of a portion of a rotor assembly of a vehicle electric machine assembly.

FIG. 3 is a fragmentary front view, in cross-section, of a portion of an example of a rotor.

FIG. 4 is a fragmentary front view, in cross-section, of a portion of another example of a rotor illustrating a demagnetization effect due to magnet stops.

FIG. 5A is a fragmentary front view, in cross-section, of a portion of an example of a rotor assembly showing a magnet in a first position.

FIG. 5B is a fragmentary front view, in cross-section, of the portion of the rotor assembly of FIG. 5A showing the magnet in a second position.

FIG. 5C is a front view of an example of a magnet for a vehicle electric machine assembly

FIG. 6 is a fragmentary front view, in cross-section, of an example of a portion of a rotor assembly.

FIG. 7 is a fragmentary detailed view of a portion of the rotor assembly of FIG. 6.

FIG. 8 is a fragmentary front view, in cross-section, of a portion of an example of a rotor assembly.

FIG. 9 is a fragmentary front view, in cross-section, of a portion of an example of a rotor assembly.

FIG. 10 is a fragmentary front view, in cross-section, of a portion of an example of a rotor assembly.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be used in particular applications or implementations.

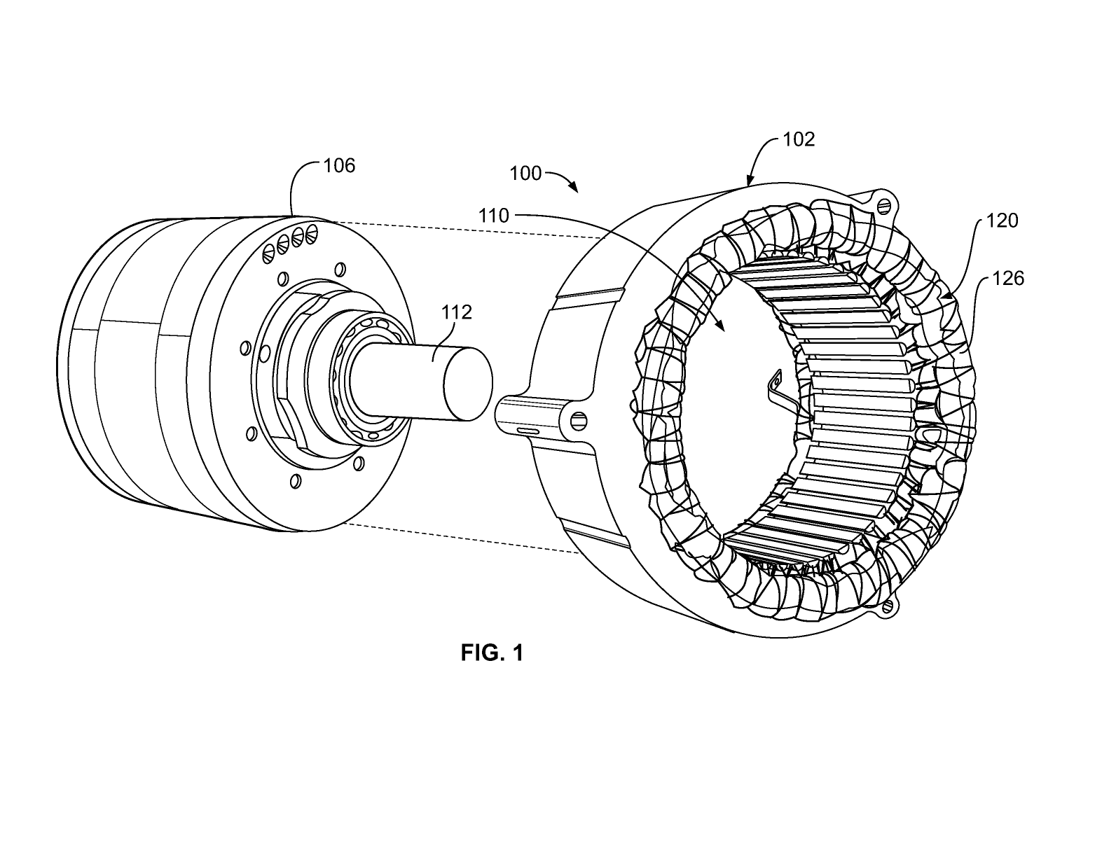

FIG. 1 is a partially exploded view illustrating an example of portions of an electric machine assembly for an electrified vehicle, referred to generally as an electric machine assembly 100 herein. The electric machine assembly 100 may include a stator core assembly 102 and a rotor assembly 106. Electrified vehicles may include more than one electric machine. One of the electric machines may function primarily as a motor and the other may function primarily as a generator. The motor may operate to convert electricity to mechanical power and the generator may operate to convert mechanical power to electricity. The stator core assembly 102 may define a cavity 110. The rotor assembly 106 may be sized for disposal and operation within the cavity 110 and may include a stack of lamination components forming one or more rotor plates. A shaft 112 may be operably connected to the rotor assembly 106 and may be coupled to other vehicle components to transfer mechanical power therefrom.

Windings 120 may be partially disposed within the cavity 110 of the stator core assembly 102. In an electric machine motor example, current may be fed to the windings 120 to obtain a force that causes the rotor assembly 106 to rotate. In an electric machine generator example, current generated in the windings 120 by a rotation of the shaft 112 may be used to power vehicle components. Portions of the windings 120, such as end windings 126, may protrude from the cavity 110. During operation of the electric machine assembly 100, heat may be generated along the windings 120. The rotor assembly 106 may include magnets such that rotation of a rotor of the rotor assembly 106 in cooperation with an electric current running through the windings 120 generates one or more magnetic fields. For example, electric current running through the windings 120 may generate a rotating magnetic field. Magnets of the rotor assembly 106 will rotate with the rotating magnetic field to generate a magnetic force at the rotor assembly 106 to rotate the shaft 112 for mechanical power.

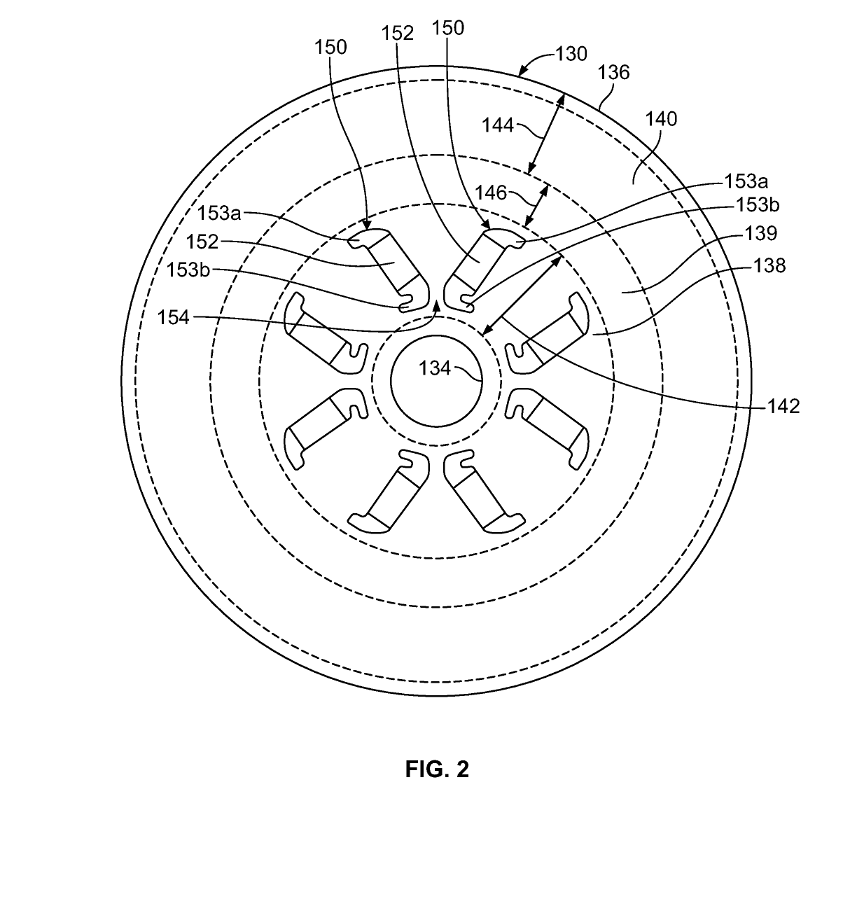

FIG. 2 illustrates an example of a rotor of a vehicle electric machine, referred to as a rotor 130. The rotor 130 includes a central through-hole 134 sized to receive a shaft (not shown), such as the shaft 112 described above, and an outer surface 136. The rotor 130 further includes an inner region 138, a middle region 139, and an outer region 140.

The inner region 138 is located adjacent the central through-hole 134 and extends radially thereabout. The inner region 138 defines a radial length 142. An inner edge of the inner region 138 may be spaced from the central through-hole 134. The outer region 140 is located adjacent the outer surface 136 and extends radially about the central through-hole 134, the inner region 138, and the middle region 139. The outer region 140 defines a radial length 144. The middle region 139 defines a radial length 146. Openings or cutouts within the regions may provide locations for mounting components and also provide reduced weight benefits.

For example, the rotor 130 may include a plurality of magnet pockets 150. In FIG. 2, the magnet pockets 150 are shown located within the inner region 138 however it is contemplated that the magnet pockets 150 may be located in the middle region 139 or the outer region 140 or may span across one or more of the regions. Additionally, it is contemplated that there may be more than one plurality of magnet pockets located in multiple rotor regions. In this example, a lower portion of each of the plurality of magnet pockets 150 may be spaced from the central through-hole 134. A central pocket region of each of the plurality of magnet pockets 150 may be sized to receive a magnet 152. The central pocket region is located between an outer pocket region 153a and an inner pocket region 153b of the magnet pocket 150. Each of the magnets 152 may be arranged upon the rotor 130 to assist in generating power when the rotor 130 rotates. The plurality of magnet pockets 150 may be arranged in pairs such that one magnet pocket of each of a pair of adjacent magnet pockets 150 is disposed on either side of a bridge region 154 of the rotor 130.

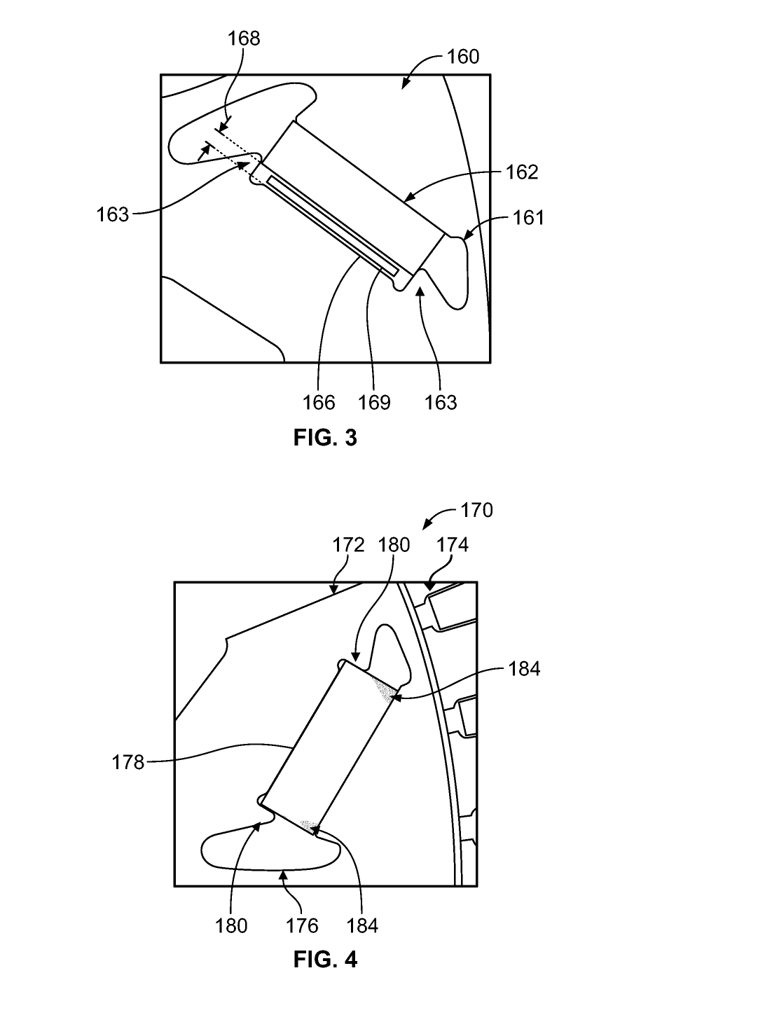

FIG. 3 is a front view, in cross-section, of a portion of a rotor, referred to generally as a rotor 160 herein. The rotor 160 includes a magnet pocket 161. A magnet 162 is disposed within a central region of the magnet pocket 161. The magnet 162 defines a substantially rectangular shape. Magnet stops 163 may assist in retaining the magnet 162 within the magnet pocket 161. The magnet 162 is spaced from an edge 166 of the magnet pocket 161 a distance 168. The edge 166 of the magnet pocket 161, the magnet stops 163, and the magnet 162 define a cavity therebetween. For example, each of the magnet stops 163 may be a portion of the rotor 160 which protrude into the magnet pocket 161. The magnet stops 163 and a size of the cavity or space between the magnet 162 and the edge 166 of the magnet pocket 161 reduces output performance of the rotor 160 by reducing an amount of magnetic flux which may be generated and thus a torque output of the motor. The distance 168 or the size of the cavity or space further provides clearance to insert the magnet 162 within the magnet pocket 161. Glue 169 is disposed within the cavity to retain the magnet 162 within the magnet pocket 161. For example, the glue 169 needs to be applied to a respective cavity of a magnet pocket prior to inserting a respective magnet. The glue 169 must then cure before a respective may be moved to a subsequent assembly step. The curing process may also require controlled temperature and humidity conditions which also adds cost and time to an assembly process in comparison to a cavity and glue described below.

FIG. 4 is a front view, in cross-section, of a portion of another rotor assembly including a rotor 170 and a stator 174. The rotor 170 includes a mount region 172. The mount region 172 includes a magnet pocket 176 and a magnet 178 disposed therein. The magnet 178 is retained in position between a pair of magnet stops 180. Each of the magnet stops 180 causes a respective demagnetization region 184 of the magnet 178. Demagnetization of these regions negatively impacts operational performance of the rotor assembly including the rotor 170. It is contemplated that the rotor 170 may be used in a vehicle electric machine or in other types of electric machines.

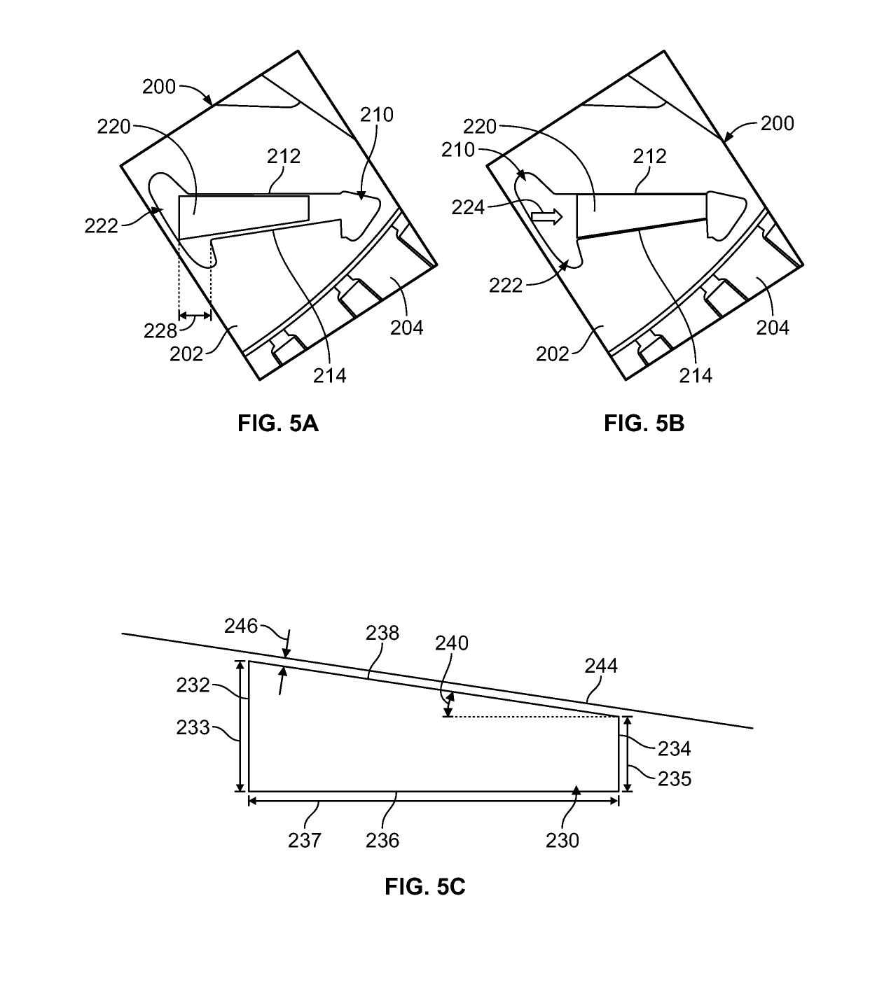

FIGS. 5A through 5C illustrate examples of rotors having wedge-shaped magnet pockets and magnets. The wedge shape eliminates or mitigates some performance issues with rotors of electric machine assemblies described above. For example, magnet stops are not included in the rotors shown in FIGS. 5A through 5C.

FIGS. 5A and 5B illustrate an example of a magnet and a magnet pocket of a portion of an electric machine assembly. The electric machine assembly includes a rotor 200 and a stator 204. The rotor 200 may include a mount region 202. For example, the mount region 202 may be one or more of an inner region, a middle region, or an outer region of the rotor 200. The mount region 202 includes a magnet pocket 210. The magnet pocket 210 includes a first side 212 and a second side 214 offset at an angle relative to the first side 212 to define a wedge shape.

A magnet 220 is sized for disposal within the magnet pocket 210. In one example, the magnet 220 may be inserted into a central pocket region of the magnet pocket 210 via an inner pocket region 222 of the magnet pocket 210 and in a direction as represented by arrow 224 of FIG. 5B. Dimension 228 is of a length based on a length necessary to provide space for insertion of the magnet 220 within the magnet pocket 210. The length is further based on an angle of the first side 212 and the second side 214 relative to one another. When the magnet 220 moves in a direction represented by arrow 224 of FIG. 5B, a wedge shape of the magnet 220 and the magnet pocket 210 may provide enough mechanical friction to keep the magnet 220 in place without a need to apply glue or another external means to hold the magnet 220 in place during assembly of the electric machine assembly including the rotor 200.

Optionally, glue may be applied between edges of the magnet pocket 210 and the magnet 220 to retain the magnet 220 therein. A type and an amount of the glue applied is different than a type and an amount of the glue 169 described above since the spacing between the edges of the magnet pocket 210 and the magnet 220 is smaller than the cavity between the magnet 162 and the edge 166 of the magnet pocket 161. A region to receive the glue between edges of the magnet pocket 210 and the magnet 220 is sized such that output performance of the rotor 200 is not hindered. For example, the region to receive the glue may be very thin as the magnet 220 is pushed in the direction of the arrow 224. This will substantially eliminate any gap between the magnet 220 and the magnet pocket 210 and improve utilization of the magnet 220 and thus improve electric machine performance. Since the glue is only needed as a secondary aide to assist in retaining the magnet 220 in place during assembly the glue does not need to be of a high strength and may be of a fast-setting type. In one example, a material of the glue is cyanoacrylates.

FIG. 5C further illustrates dimensional relationships of sides of a wedge-shaped magnet for insertion into a wedge-shaped magnet pocket. A magnet 230 may include a first vertical side 232 having a first length 233 and a second vertical side 234 having a second length 235. The first length 233 may be greater than the second length 235. The magnet 230 may further include a first non-vertical side 236 having a third length 237 less than a fourth length of a second non-vertical side 238. The first non-vertical side 236 and the second non-vertical side 238 may be arranged with one another so they are not in a parallel orientation relative to one another. The second non-vertical side 238 may extend from the second vertical side 234 at an angle 240. The angle 240 may have a degree value between zero and ninety degrees. In one example, the angle 240 may have a degree value between 0.2 and 20 degrees. The first vertical side 232, the second vertical side 234, the first non-vertical side 236, and the second non-vertical side 238 may be arranged with one another to define a wedge shape.

The second non-vertical side 238 may be spaced from an edge 244 of a magnet pocket a cavity length 246. The sides of the magnet 230 may be sized relative to one another and arranged with one another to define a length value for the dimension 228 (as described relative to FIG. 5A) such that the magnet 230 may be inserted within a magnet pocket. For example, the dimension 228 may be equal to:

((2)(cavity length 246)(third length 237))/((first length 233)²−(second length 235)²)

A tangent of angle 240 may be equal to:

(first length 233−second length 235)/(third length 237)

In an example in which dimension 228=4 mm, first length 233 may be=5.6 mm, second length 235 may be=5.2 mm, cavity length 246 may be=0.1 mm, and third length 237 may be=16.1 mm. In an example in which dimension 228=2.7 mm, first length 233 may be=5.6 mm, second length 235 may be=5.3 mm, cavity length 246 may be=0.1 mm, and third length 237 may be equal to 15.9 mm. It is contemplated that the rotor 200 may be used in a vehicle electric machine or in other types of electric machines.

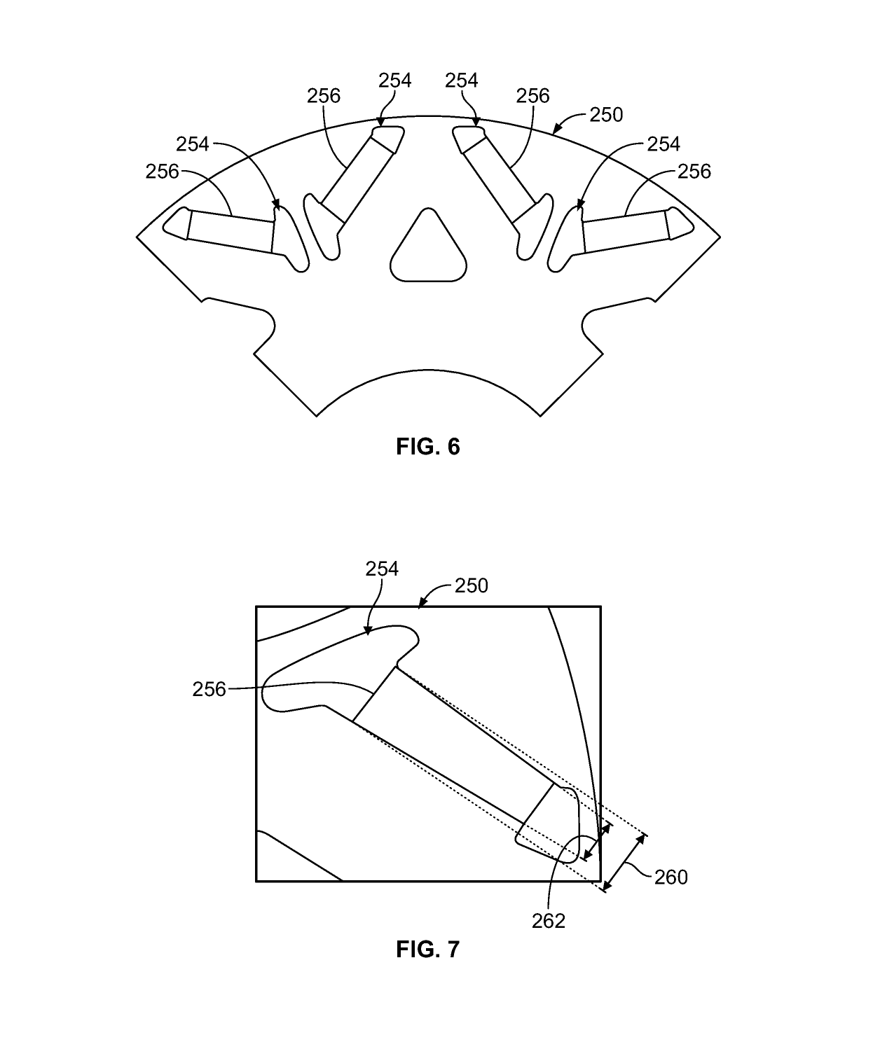

FIGS. 6 and 7 illustrate an example of a portion of a rotor, referred to as a rotor 250 herein, including a wedge-shaped portion of a magnet pocket to eliminate issues described above relating to magnet stops and spacing between a magnet and an edge of a magnet. The rotor 250 may include a plurality of magnet pockets 254. Each of a plurality of magnets 256 may be disposed within one of the plurality of magnet pockets 254.

FIG. 7 illustrates further detail of a structure of each of the plurality of magnet pockets 254 and each of the plurality of magnets 256. For example, each of the plurality of magnet pockets 254 is wedge-shaped having a first end defining a first width 260 and a second end defining a second width 262. It is contemplated that one or both long sides of each of the plurality of magnets 256 may be offset at an angle relative to one another. The first width 260 may be greater than the second width 262. The first end of each of the plurality of magnets 206 may be located closer to a central region or shaft aperture of the rotor 250 in comparison to the second end of each of the plurality of magnets 256. Each of the magnets 256 may be shaped correspondingly with the respective magnet pocket 254 to have an end with a greater width than another end.

The wedge shape of the magnet pocket 254 eliminates a need for a clearance space and glue between an edge of the magnet pocket 254 and magnet 256 and eliminates a need for magnet stops to retain the magnet 256 within a magnet pocket 254 as described in relation to FIG. 2. Further, a risk of demagnetization as described in relation to FIG. 3 is reduced by eliminating the magnet stops described in relation to the rotor 160 and the rotor 170. Additionally, centripetal force created by rotation of the rotor 250 influences each of the magnets 256 to move toward an outer edge of the rotor 250 since the first width 260 is greater than the second width 262. Each of the first width 260 and the second width 262 may be of a length corresponding to a size of a respective magnet pocket, such as the magnet pocket 254, and of a length corresponding to a desired rotor torque production. It is contemplated that the rotor 250 may be used in a vehicle electric machine or in other types of electric machines.

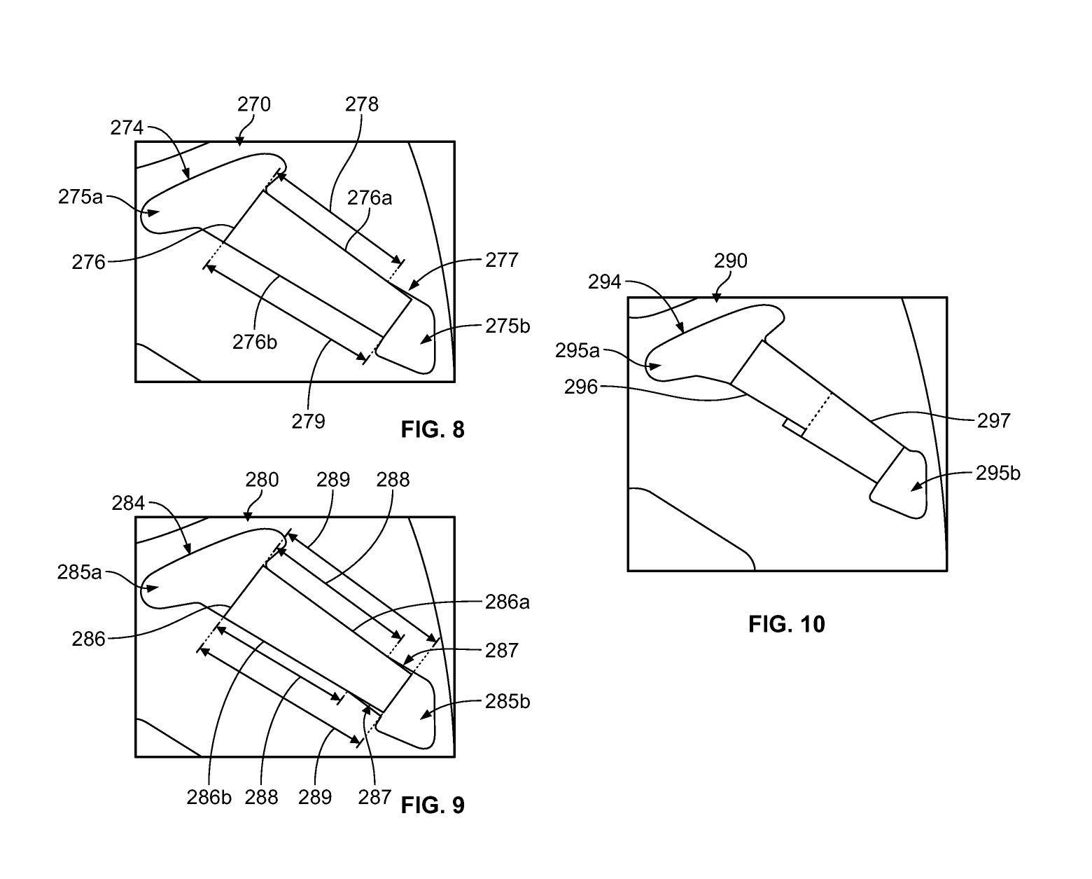

FIGS. 8 through 10 illustrate additional examples of portions of rotors including a wedge-shaped magnet pocket to eliminate issues described above relating to magnet stops and spacing between a magnet and an edge of a magnet pocket.

In FIG. 8, a portion of a rotor 270 is shown. The rotor 270 may include a plurality of magnet pockets 274 each having an inner pocket region 275a and an outer pocket region 275b. Each of a plurality of magnets 276 may be disposed within a central pocket region between the inner pocket region 275a and the outer pocket region 275b of one of the plurality of magnet pockets 274. Each of the plurality of magnets 276 may include a first side 276a and a second side 276b. The second side 276b may be offset at an angle relative to the first side 276a to, for example, provide a wedge shape to assist in inserting and retaining the magnet 276 into the magnet pocket 274. The outer pocket region 275b may include an outcrop region 277 extending into the central region of the magnet pocket 274. A wedge shape of each of the central regions of each of the plurality of magnet pockets 274 may define a pocket length 278. In this example, the pocket length 278 extends to an edge of the outcrop region 277. Each of the plurality of magnets 276 may define a magnet length 279 greater than a length of the pocket length 278.

In FIG. 9, a portion of a rotor 280 is shown. The rotor 280 may include a plurality of magnet pockets 284 each having an inner pocket region 285a and an outer pocket region 285b. Each of a plurality of magnets 286 may be disposed within a central pocket region between the inner pocket region 285a and the outer pocket region 285b of one of the plurality of magnet pockets 284. Each of the plurality of magnets 286 may include a first side 286a and a second side 286b. The second side 286b may be offset at an angle relative to the first side 286a to, for example, provide a wedge shape to assist in inserting and retaining the magnet 286 into the magnet pocket 284. The outer pocket region 285b may include two outcrop regions 287 extending into the central pocket region of the magnet pocket 284. A wedge shape of each of the plurality of magnet pockets 284 may define a pocket length 288. In this example, the pocket length 288 extends to an edge of each of the two outcrop regions 287. Each of the plurality of magnets 286 may define a magnet length 289 greater than a length of the pocket length 288.

In FIG. 10, a portion of a rotor 290 is shown. The rotor 290 may include a plurality of magnet pockets 294 each having an inner pocket region 295a and an outer pocket region 295b. Each of a plurality of magnets may be disposed within a central pocket region between the inner pocket region 295a and the outer pocket region 295b of one of the plurality of magnet pockets 294. In this example, the central pocket region of the magnet pocket 294 defines an irregular or non-uniform shape. As such, a first magnet 296 and a second magnet 297 may be disposed within the magnet pocket 294. It is contemplated that the first magnet 296 and the second magnet 297 may be formed as a single unit, however the single unit may be more expensive to manufacture than a separate unit for the first magnet 296 and a separate unit for the second magnet 297. The first magnet 296 and the second magnet 297 may be identical units. It is contemplated that each of the rotor 270, the rotor 280, and the rotor 290 may be used in a vehicle electric machine or in other types of electric machines. It is also contemplated that a rotor may have various sized and shaped magnet pockets. For example, a rotor may include one or more of the magnet pocket 210, the magnet pocket 254, the magnet pocket 274, the magnet pocket 284, and/or the magnet pocket 294.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A rotor for an electric machine assembly comprising:
a rotor mount region extending radially about a shaft through-hole; and
a plurality of magnet pockets defined within the rotor mount region, each magnet pocket including a central pocket region between an outer pocket region and an inner pocket region,
wherein the central pocket region is sized to receive a magnet having a wedge shape.

2. The assembly of claim 1, wherein the central pocket region and the magnet each have a first side offset at an angle relative to a second side.

3. The assembly of claim 1, wherein the outer pocket region defines an outcropped portion extending into the central pocket region, and wherein a length of the magnet is greater than a length between an edge of the magnet adjacent the inner pocket region and an edge of the outcropped portion adjacent the central pocket region.

4. The assembly of claim 1, wherein the central pocket region defines a non-uniform shape, and wherein the magnet comprises two separate magnet units of equal size and shape to fit within the non-uniform shape of the central pocket region.

5. The assembly of claim 1, wherein a respective magnet is spaced from an edge of a respective magnet pocket by a cavity length, wherein the magnet includes a first side defining a first non-vertical length, wherein the magnet includes a second side defining a first vertical length greater than a second vertical length defined by a third side, and wherein a distance between an edge of the outer pocket region and an edge of the magnet when located within the central pocket region is substantially equal to ((2)(the cavity length)(the first non-vertical length))/((the first vertical length)²−(the second vertical length)).

6. The assembly of claim 1, wherein the magnet includes a first vertical side defining a first vertical length, a second vertical side defining a second vertical length, and a third non-vertical side defining a first non-vertical length, and wherein a tangent of an angle between a second non-vertical side extending from the second vertical side is substantially equal to (the first vertical length−the second vertical length)(the first non-vertical length).

7. The assembly of claim 1, wherein the central pocket region and the magnet each has a first side offset at an angle relative to a second side and such that the first side and the second side are not oriented parallel with one another.

8. A vehicle electric machine assembly comprising:
a stator core defining a cavity; and
a rotor assembly at least partially disposed within the cavity and including a rotor defining one or more magnet pockets,
wherein each of the magnet pockets includes a central pocket region between an outer pocket region and an inner pocket region, wherein the outer pocket region defines an outcrop extending into the central pocket region, and wherein a length of a magnet located within the central pocket region extends past an edge of the outcrop.

9. The assembly of claim 8, wherein the rotor does not include a magnet stop located adjacent the magnet pockets.

10. The assembly of claim 8, wherein the central pocket region defines an irregular shape, and wherein the magnet comprises two separate magnet units of equal size and shape such that both magnet units fit next to one another within the irregular shape of the central pocket region.

11. The assembly of claim 8, wherein the magnet and an edge of the central pocket region define a cavity therebetween having a width such that magnetic flux generated by the magnet is not hindered when the rotor rotates.

12. The assembly of claim 8 wherein a respective magnet is spaced from an edge of a respective magnet pocket by a cavity length, wherein the magnet includes a first side defining a first non-vertical length, wherein the magnet includes a second side defining a first vertical length greater than a second vertical length defined by a third side, and wherein a distance between an edge of the outer pocket region and an edge of the magnet when located within the central pocket region is substantially equal to ((2)(the cavity length)(the first non-vertical length))/((the first vertical length)²−(the second vertical length)).

13. The assembly of claim 8, wherein the magnet includes a first vertical side defining a first vertical length, a second vertical side defining a second vertical length, and a third non-vertical side defining a first non-vertical length, and wherein a tangent of an angle between a second non-vertical side extending from the second vertical side is substantially equal to (the first vertical length−the second vertical length)(the first non-vertical length).

14. The assembly of claim 8, wherein the central pocket region includes a first side offset at an angle relative to a second side such that the first side and the second side are not oriented parallel to one another.

15. A vehicle electric machine assembly comprising:
a stator core defining a cavity; and
a rotor assembly disposed at least partially within the cavity and including a rotor defining a central shaft through-hole and a magnet pocket sized to receive a wedge-shaped magnet having a first end defining a width greater than a width of a second end,
wherein the central shaft through-hole and the magnet pocket are arranged with one another such that the first end of the wedge-shaped magnet is located closer to the central shaft through-hole than the second end of the wedge-shaped magnet.

16. The assembly of claim 15, wherein the rotor does not include a magnet stop located adjacent the magnet pockets.

17. The assembly of claim 15, wherein a central pocket region of the magnet pocket defines an irregular shape, and wherein the magnet comprises two separate magnet units of equal size and shape such that both magnet units fit next to one another within the irregular shape of the central pocket region.

18. The assembly of claim 15, wherein the wedge-shaped magnet is spaced from an edge of the magnet pocket by a cavity length, wherein the wedge-shaped magnet includes a first side defining a first non-vertical length, wherein the wedge-shaped magnet includes a second side defining a first vertical length greater than a second vertical length defined by a third side, and wherein a distance between an edge of an outer pocket region of the magnet pocket and an edge of the wedge-shaped magnet when located within a central pocket region of the magnet pocket is substantially equal to ((2)(the cavity length)(the first non-vertical length))/((the first vertical length)²−(the second vertical length)).

19. The assembly of claim 15, wherein the magnet includes a first vertical side defining a first vertical length, a second vertical side defining a second vertical length, and a third non-vertical side defining a first non-vertical length, and wherein a tangent of an angle between a second non-vertical side extending from the second vertical side is substantially equal to (the first vertical length−the second vertical length)(the first non-vertical length).

20. The assembly of claim 15, wherein the first end of the wedge-shaped magnet is arranged with the central shaft through-hole such that a centripetal force generated by rotation of the rotor influences the magnet to move toward an outer edge of the rotor.
